(19) United States
(12) Patent Application Publication
(10) Pub. No.: US 2006/0101372 A1
(43) Pub. Date: May 11, 2006

(54) Method, system, and software for determining platform management functionality

(75) Inventors: Haihong Zhuo, Austin, TX (US); Anil V. Rao, Austin, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 10/985,198

(22) Filed: Nov. 10, 2004

(51) Int. Cl. G06F 9/44

(52) U.S. Cl. 717/100

(57) ABSTRACT

A profiling program or function can determine functionality, e.g. which commands and/or command parameters are supported, of a platform management subsystem. Information about the system's functionality can be provided to instrumentation code, presentation layer software applications, or the like, allowing an intelligent determination about which platform management options to expose to a system's user.

### TECHNICAL FIELD

The present disclosure relates generally to platform management interfaces, and more particularly to determining which platform management options are supported by a particular implementation of a platform management interface.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many information handling systems provide platform management subsystems capable of monitoring and controlling, either locally or remotely, various hardware subsystems and functions such as voltages, temperatures, fan speeds, and the like. These platform management subsystems are generally accessed through an Intelligent Platform Management Interface (IPMI), which is a standard interface to the platform management subsystem.

Although IPMI defines a standard interface for platform management subsystems, IPMI allows vendors to support different subsets of parameters for various commands. Additionally, the IPMI specification defines some commands as optional, and not all vendors provide platform management subsystems that support the entire universe of optional commands. These variations in IPMI implementation pose challenges to the interoperability of system management software, at least in part because issuing an unsupported command or command option to a platform management subsystem can cause the platform management subsystem to stop responding, or to respond in an unexpected or undesired manner.

The IPMI 1.5 specification allows a user to determine if a command is supported by a platform management system by issuing the command and checking the status returned from firmware. The IPMI 2.0 specification provides a command that allows a user to determine if other commands are supported, without requiring the other commands to be issued.

Some software accounts for variations in implementation of supported commands and parameters across different platforms by maintaining a list of options supported by particular system ID's. Using the system ID in this way requires software updates whenever support for a new platform is added, or when command implementation is changed on a platform.

### SUMMARY

In accordance with teachings of the present disclosure, a system, method and software are described for determining the functionality, e.g. supported commands and command parameters, of a platform management subsystem, and providing that information to software applications such as instrumentation level and presentation layer applications. By providing information about platform management functionality, to software applications, the software can intelligently determine which platform management options to expose to a system's user. Furthermore, the software can use the information to prevent an unsupported command or command option from being issued to a platform management subsystem.

According to at least one embodiment, a single implementation of system management software, particularly the instrumentation software and related graphical user interface (GUI) framework, can be applied to different platforms, from different vendors, implementing different IPMI versions. The flexibility of such an embodiment may provide reduced software development cycles and reduce a product's Time to Market.

A method according to an embodiment of the present disclosure includes determining whether functionality associated with respective commands is supported by the platform management subsystem, and storing the results of the determination in a file accessible to at least presentation layer applications. The functionality so determined may include identifying supported commands and command parameters. According to at least one embodiment, the method attempts to set a command parameter to each of a plurality of parameter values, and determines if the respective parameter values are supported based on a completion code provided by the platform management subsystem.

Supported commands may be determined, according to various embodiments, by commanding the platform management subsystem to identify supported commands, or by issuing a command and evaluating the completion code returned. Some embodiments create or modify a file to include information identifying supported commands or command codes. This file can be accessed by software to provide improved user interaction, and to prevent issuing unsupported commands or setting unsupported command parameters.

In one form, a method according to an embodiment of the disclosure is embodied as a program of executable instructions encoded in a computer readable medium. A program of instructions according to at least one such embodiment includes at least one instruction to determine whether functionality associated with respective commands is supported by a platform management subsystem, and at least one instruction to store results of the determination in a file accessible to software.

In yet another embodiment, an information handling system is provided. The information handling system includes a platform management subsystem, a processor and associated memory, and a program of instructions to be stored in the memory and executed by the processor. The program of instructions implements a method that includes determining whether functionality associated with respective commands is supported by the platform management subsystem, and storing results of the determination in a file accessible to at least presentation layer applications.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram illustrating an information handling system including an Intelligent Platform Management subsystem according to an embodiment of the present disclosure.

FIG. 2 is a diagram illustrating the relationship of an IPMI subsystem, software applications, and a profiling program or function according to an embodiment of the present disclosure.

FIG. 3 is a flow diagram illustrating a method of profiling command parameters supported by a platform management subsystem according to an embodiment of the present invention.

FIG. 4 is a flow diagram illustrating a method of profiling supported commands according to an embodiment of the present invention.

### DETAILED DESCRIPTION

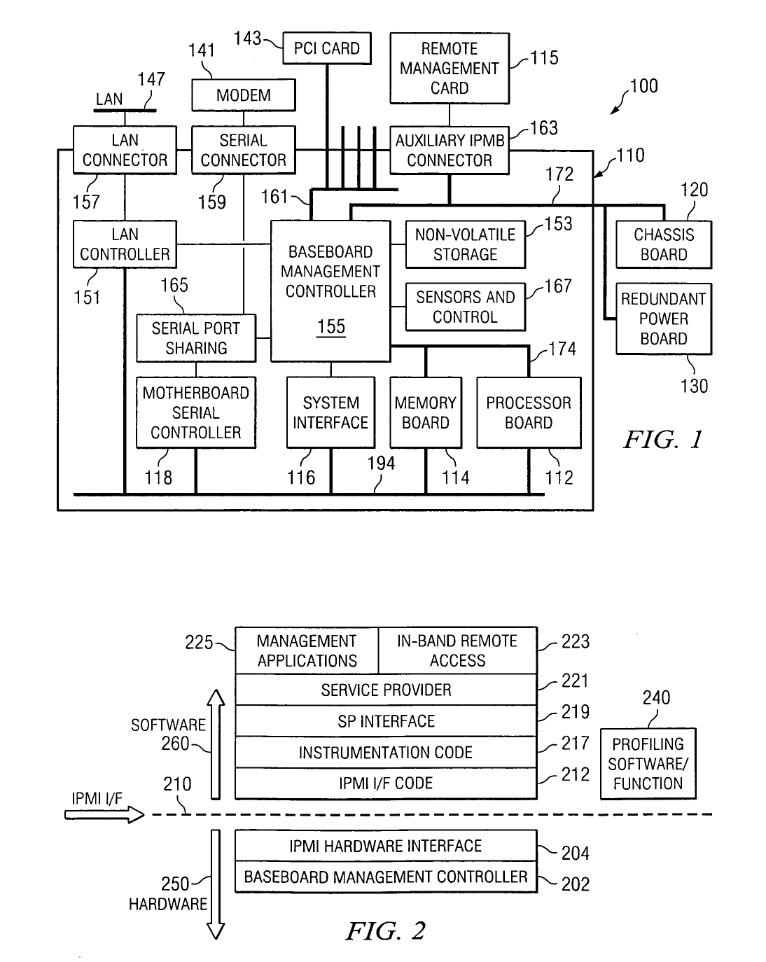

Preferred embodiments and their advantages are best understood by reference to FIGS. 1 through 4, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring first to FIG. 1, one such information handling system will be discussed according to an embodiment of the present disclosure. Information handling system 100 includes motherboard 110, chassis board 120, redundant power board 130, modulator demodulator (modem) 141, peripheral component interconnect (PCI) card 143, remote management card 115, and local area network (LAN) 147. Information handling system 100 may also include various interface devices, storage devices, and the like, which are not illustrated.

Motherboard 110 includes processor board 112, memory board 114, system interface 116, LAN controller 151, non-volatile storage 153, and baseboard management controller (BMC) 155. Motherboard 110 also includes various connectors, e.g. LAN connector 157, serial connector 159, PCI connectors 161, intelligent platform management bus (IPMB) connector 163, serial port sharing circuitry 165, and various sensors and controls 167.

BMC 155 is connected to the various illustrated devices via management busses. BMC 155 is connected, for example, to PCI card 143 by PCI management bus 161; to chassis board 120, remote management card 115, and redundant power supply board 130 by IPMB 172; to memory board 114 and processor board 112 by private management busses 174.

In at least one embodiment, BMC 155 receives sensor information associated with processor voltages, fan speed, temperature, etc., from sensors and control 167, chassis board 120, and redundant power board 130, and provides that information to a user. BMC 155 may provide the information to the user via remote management card 115, system bus 194, modem 141, serial controller 118, or LAN 147 using either in-band or out of band communications. Information received via system bus 194, LAN 147, modem 141, or remote management card 115 may be used to change voltages and fan speeds, or otherwise control PCI card 143, chassis board 120, redundant power board 130, processor board 112, etc.

Consider the following example, in which the redundant power board 130 is to be brought on-line due to fluctuations in processor voltage. BMC 155 receives voltage readings from sensors and control 167 indicating that the processor voltage is not being properly regulated. The readings, or alarms based on the readings in some embodiments, are provided to a remote monitoring system using remote management card 115.

In one embodiment, the remote system (not illustrated) presents the user with a list of supported commands and command parameters associated with control of redundant power board 130. The user may select an appropriate command, and the remote system sends the selected command back to BMC 155. BMC 155 executes the selected command by taking the primary power supply (not illustrated) off-line, and bringing the redundant power board on-line in its place.

In at least one embodiment, communication between the BMC, which is part of an intelligent platform management system, and the remote server, is controlled by software that provides an interface between the hardware/firmware level and higher level, software applications.

Referring next to FIG. 2, Profiling Software/Function 240 will be discussed according to an embodiment of the present disclosure. The dashed line 210 represents the interface between software 260 and hardware 250.

Hardware 250 may include a baseboard management controller (BMC) 202, and a hardware/firmware interface such as IPMI H/W interface 204. Software 260 may include IMPI I/F Code 212, instrumentation code 217, service provider (SP) interface 219, service provider software 221, in-band remote access software 223, and management applications 225.

In one embodiment, as the first layer between IPMI H/W interface 204 and other software applications IPMI I/F code 212 abstracts data from Hardware 250, maps the abstractions to a data model that is understandable by the higher level software, and converts requests from software 260 to hardware 250. In at least one embodiment, a system employing IPMI I/F code 212 provides support of IPMI version 1.5 and above using the same code base, regardless of the platform vendor.

At least one embodiment of the present disclosure includes a profiling software/function 240 that executes upon initial installation of the program, at boot time, periodically, upon installation of a program update, or at other scheduled or unscheduled times as deemed appropriate consistent with the teachings set forth herein. In some embodiments, the profiling software function 240 is installed and executed independent of IPMI I/F code 212, while other embodiments incorporate the functions of profiling software/function 240 into IMPI I/F code 212.

According to at least one embodiment, the profiling software/function 240 determines which command and parameter options are supported by the hardware. In some embodiments, the profiling program generates one or more files that include information identifying the supported IPMI commands and/or parameters. In other embodiments, one or more pre-existing files are modified to include this information. Regardless of whether the files are generated originally by the profiling program, or are modified by the profiling program, the files including information about which commands and profiles are supported are made available to the software applications such as instrumentation code 217 and management applications 225. The file may be used in some embodiments to provide improved usability and/or prevent a user from inadvertently setting an unsupported command/parameter combination to firmware.

Providing awareness of platform management functionality to higher level software may be advantageous, for example, where the supported options for obtaining an IP address source differ from one manufacturer of platform management systems to another. In one instance, a first manufacturer may support obtaining an Internet protocol (IP) address through DHCP, but not support configuring an IP address using a system's basic input output system (BIOS). A second manufacturer may not support obtaining an IP address through DHCP, but may support configuring the IP address through BIOS. Consider also that although five different baud rates (9600, 19200, etc) may be supported in a particular implementation of IPMI, a given platform may only support four of the five baud rates.

Additionally, some versions of the IPMI specification provide for optional commands, such as the GetAuxiliaryLogStatus command, or original equipment manufacturer (OEM) defined commands. Some vendors may choose to support a particular optional command, or to implement a custom OEM command, while others do not.

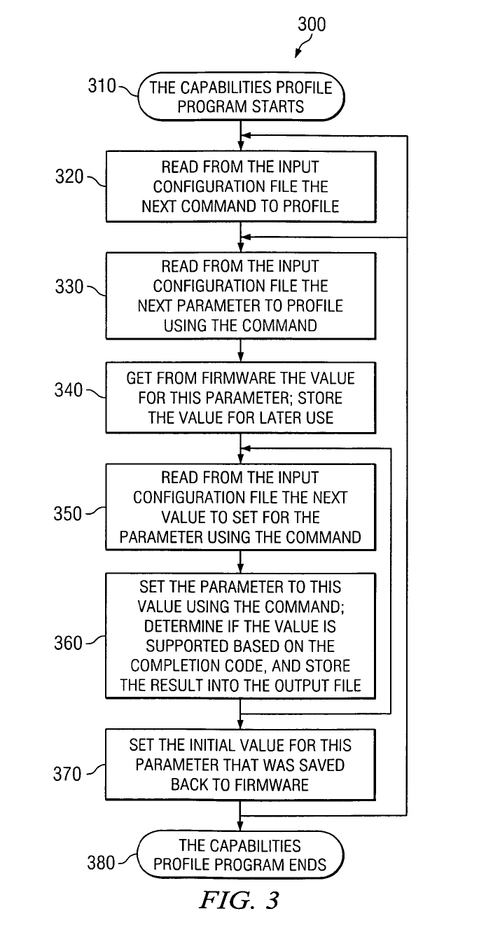

Referring next to FIG. 3, a method 300 of profiling supported command parameters to determine which command parameters are supported by a particular platform will be discussed according to an embodiment of the present disclosure. Execution of method 300 begins at 310. Method 300 may be implemented as a standalone capabilities profile program or function according to an embodiment of the present disclosure. Method 300 may also be implemented as part of IPMI interface (I/F) code (see FIG. 2), as firmware executed under control of a BIOS, as a part of an operating system, or the like. In at least one embodiment, method 300 is performed upon initial power-up of a system to determine variations in command options supported by the system. In other embodiments, method 300 may be performed during initial system configuration during manufacturing or after hardware replacement.

The method determines which command to profile at 320, based on data from an input configuration file, e.g. an input.ini or an input.XML file. In at least one embodiment, the configuration file includes commands supported by the system on which method 300 is being implemented and parameters associated with those commands. Content representative of a configuration file according to an embodiment of the present disclosure is presented below:

#// ---- Set cmds to profile ----
[BMC Command Section]
bmccmd.0x00=SetLANConfig
bmccmd.0x01=SetSerialConfig
bmccmd.0x02=SetSOLConfig
bmccmd.0x03=SetPEFConfig
bmccmd.0x04=...
#// ---- LAN config param to profile ----
[SetLANConfig]
NetFnLUN=0x18
CMD=0x01
bmcattr.0x00=IPAddrSrc
bmcattr.0x01=...
[GetLANConfig]
NetFnLUN=0x18
CMD=0x02
#// ---- Info for IP address source ----
[IPAddrSrc]
dataattrib=EMPLANConfigObj.IPAddrSource
channel=LAN
getcmd= GetLANConfig
getdatalen=4
getreqdata=channel,0x04,0x00,0x00
setopt.0x01= IPAddrSrc.static
setopt.0x02= IPAddrSrc.DHCP
setopt.0x03= IPAddrSrc.BIOS
[IPAddrSrc.static]
setdatalen=3
setreqdata=channel,0x04,0x01
ccode=0xCC
sptvalue=BIT[1]
[IPAddrSrc.DHCP]
setdatalen=3
setreqdata=channel,0x04,0x02
ccode=0xCC
sptvalue=BIT[2]
[IPAddrSrc.BIOS]
setdatalen=3
setreqdata=channel,0x04,0x03
ccode=0xCC
sptvalue=BIT[3]
#// ---- Serial config param to profile ----
[SetSerialConfig]
NetFnLUN=0x18
CMD=0x10
attrcfg.0x00=ConnMode
attrcfg.0x01=...
[GetSerialConfig]
NetFnLUN=0x18
CMD=0x11
#// ---- Info for Connection Mode ----
[ConnMode]
dataattrib=EMPSerialConfigObj.connectionMode
channel=Serial
getcmd=GetSerialConfig
getdatalen=4
getreqdata=channel,0x03,0x00,0x00
setopt.0x01= ConnMode.modem_basic
setopt.0x02= ConnMode.modem_terminal
setopt.0x03= ConnMode.direct_basic
[ConnMode.modem_basic]
setdatalen=3
setreqdata=channel,0x03,0x01
ccode=0xCC
sptvalue=BIT[0]
[ConnMode.modem_terminal]
setdatalen=3
setreqdata=channel,0x03,0x04
ccode=0xCC
sptvalue=BIT[2]
[ConnMode.direct_basic]
setdatalen=3
setreqdata=channel,0x03,0x81
ccode=0xCC
sptvalue=BIT[3]

So, for example, for an input configuration file including the above information, the BMC command SetLANConfig may be selected for profiling at 320.

The method proceeds to 330, where one of the parameters associated with the selected command, SetLANConfig in the present example, is chosen for profiling. Assuming that none of the parameters associated with the BMC command SetLANConfig command have been previously profiled, at least one embodiment of method 300 may select the BMC attribute IPAddrSrc for profiling.

The current value of the selected command parameter, e.g. IPAddrSrc, is read from firmware at 340, and stored for later use. The method then proceeds to 350, where a parameter value to be profiled is read from the input configuration file. At 360 the method sets the parameter to the value obtained at 350 and issues the selected command with the newly set parameter value. Issuing the command will result in the BMC returning a completion code, which is used to determine whether the parameter is supported by the system. The result, e.g. whether or not the parameter is supported, is written to an output file, and the method returns to 350 to evaluate the next value of the parameter.

In at least one embodiment, once all of the parameter values for a particular command have been profiled, the method proceeds to 370. At 370 the parameter is returned to its initial value, which was read from firmware at 340. In this manner, method 300 can avoid inadvertently leaving a parameter value set to an unsupported value.

After setting the parameter value to its original state, method 300 loops back to 330, and the next parameter is chosen for profiling. The method determines, for each possible value of the newly selected parameter, whether the value is supported, and writes the results to the output file in the manner previously discussed.

Once all parameters for a particular command have been profiled, the method returns to 320 to read the next command to be profiled. Method 300 continues in this manner until the commands, parameters, and values identified in the input configuration file have been profiled.

Consider the following example using an input configuration file as discussed above. Assume that the SetLANConfig is the command selected at 320, and that the IPAddrSrc parameter is selected at 330. The method 300 will issue the SetLANConfig command with the IPAddrSrc parameter set to static, and receive a completion code from the platform management subsystem indicating whether the command executed successfully. If the completion code indicates that the command executed successfully, an output file will be generated and/or updated to reflect that the IPAddrSrc parameter supports a value of “static.” Method 300 will then set the IPAddrSrc to DHCP and BIOS, in turn, and update the output file to reflect whether the respective values are supported.

Method 300 may then select the SetSerialConfig command to be profiled, and select the ConnMode parameter as the first parameter to profile. The SetSerialConfig command will be issued with the ConnMode set to Conmodem_basic, modem_terminal, and direct_basic in turn, using the completion code returned by the platform management subsystem to determine if the respective parameters are supported. The results can be stored in the output file, and the method will continue to profile remaining commands and parameters in the input configuration file.

In at least one embodiment, the output file e.g. output.xml, can be used by other applications, such as presentation layer applications, to determine supported options, or by instrumentation software to populate attributes for capabilities, which can then be used by higher level applications. An output file according to various embodiments of the present invention may also be used by other applications consistent with the teachings set forth herein.

An example of information included in an output file according to an embodiment of the present invention is presented below. Continuing with the previous example, the output file below illustrates that values of “static” and “DHCP” are supported for the parameter IPAddrSrc, but the value “BIOS” is unsupported. Similarly, the value “direct_basic” is supported for the parameter ConnMode, but the values “modem_basic” and “modem_terminal” are not.

```
<EMPLANConfigObj>
    <IPAddrSrce>
        <static>true</static>
        <DHCP>true</DHCP>
        <BIOS>false</BIOS>
    </IPAddrSource>
</EMPLANConfigObj>
<EMPSerialConfigObj>
    <connectionMode>
        <modem_basic>false</modem_basic>
        <modem_terminal>false</modem_terminal>
        <direct_basic>true</direct_basic>
    </connectionMode >
</EMPSerialConfigObj >
```

It will be appreciated that although only two commonly used BMC configuration commands are discussed above, with only one parameter for each, the same principles apply equally well to the fairly large number of command/parameter/value combinations that may be profiled. At least one embodiment of method 300 can save a linearly increased amount of code work over requiring each command/parameter/value combination to be specifically coded in a program. When adding new combinations according to at least one such embodiment, the input configuration file is updated, but the binary program does not need to be updated.

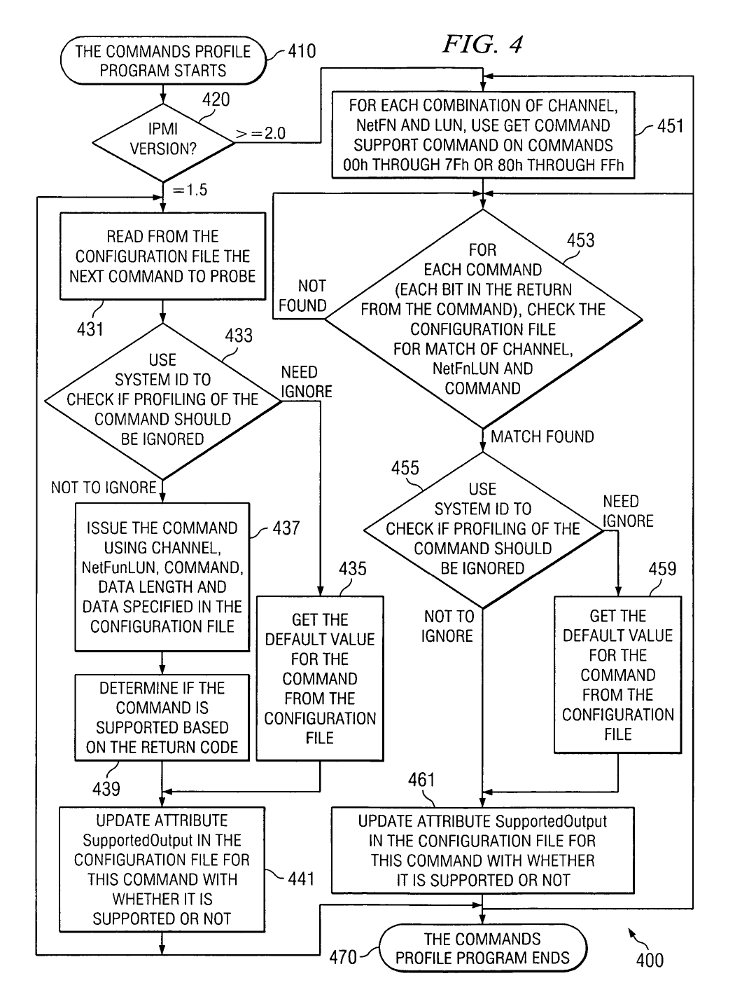

Referring next to FIG. 4, a method 400 for determining if commands are supported by a platform will be discussed according to an embodiment of the present disclosure. Recall that the illustrated embodiment of method 300 (FIG. 3) may be used to determine which command parameters are supported by a particular platform. Method 400, similarly, may be used to determine which commands are supported by a platform. Used in conjunction, methods 300 and 400 may be used to profile supported BMC commands and command parameters.

Execution of method 400 begins at 410. Method 400 may be implemented as a commands profile program or function according to an embodiment of the present disclosure, and may be implemented as part of an IPMI I/F code (see FIG. 2), as firmware executed under control of a BIOS, as a standalone program executed under control of a system level operating system, or the like. In at least one embodiment, method 400 is performed upon initial power-up of a system to determine variations in command options supported by the system.

At 420, method 400 determines whether the platform on which method 400 is being performed is IPMI version 1.5 or 2.0. It should be noted that although method 400 is discussed in terms of IPMI versions 1.5 and 2.0, various methods may be implemented with other IPMI versions, or with other suitable platform management interface.

For IPMI 1.5 platforms, the method proceeds to 431, and obtains a command to be evaluated. In at least one embodiment, the command to be evaluated is obtained by reading the command from a command configuration file, e.g. command.ini or command.XML. An example of information that may be included in a command configuration file according to an embodiment of the invention is presented below. Note that the information shown is representative of a command configuration file prior to being modified by method 400.

#// ---- cmds to profile ----
[BMC Command Section]
bmccmd.0x00=GetAuxiliaryLogStatus
bmccmd.0x01=RestoreDefaults
bmccmd.0x02=...
#// ---- Info for Get Auxiliary Log Status ----
[GetAuxiliaryLogStatus]
IgnoreProlileOn=comma_delimited_list_of_system_IDs
ForceSupportOn=comma_delimited_list_of_system_IDs
Channel=IPMB
NetFnLUN=0x28
CMD=0x5A
ReqDataLen=1
ReqData=1
CCode=0xC1
SupportedDefault=True
SupportedOutput=
#// ---- Info for Restore Defaults ----
[RestoreDefaults]
IgnoreProlileOn=comma_delimited_list_of_system_IDs
ForceSupportOn=comma_delimited_list_of_system_IDs
Channel=IPMB
NetFnLUN=0xF8
CMD=0x0D
ReqDataLen=1
ReqData=0
CCode=0xC1
SupportedDefault=False
SupportedOutput=

Method 400 proceeds to 433, where the system ID is used to determine if the command should be profiled, or if the command should be ignored. According to at least one embodiment, if the command is not to be profiled the command's default value is read from the configuration file at 435 as the final value. The final value may then be used at 441 to update an attribute of the command, e.g. SupportedOutput, in the command configuration file to indicate whether the command it is supported or not. After updating the command configuration file at 441, method 400 may return to 431 to determine if additional commands are supported.

If method 400 determines at 433 that the command should be profiled, the method proceeds to 437, where the command is issued to the platform management system. In at least one embodiment, the command is issued using the channel, NetFnLUN, command, data length and data provided by the command configuration file.

In the illustrated embodiment, platform management firmware will return a completion code indicating whether the issued command successfully completed. Method 400 can use the completion code at 439 to determine whether the issued command is supported by the platform. If the completion code from firmware indicates that the command is supported on this platform, the method proceeds to 441 where the command configuration file is updated accordingly. After updating the command configuration file at 441, method 400 may return to 431 to determine if additional commands are supported.

An example of information included in a command configuration file that has been updated according to method 400 is presented below. Note that the command configuration file shown below indicates that the GetAuxiliaryLogStatus command is not supported.

#// ---- cmds to profile ----
[BMC Command Section]
bmccmd.0x00=GetAuxiliaryLogStatus
bmccmd.0x01=RestoreDefaults
bmccmd.0x02=...
#// ---- Info for Get Auxiliary Log Status ----
[GetAuxiliaryLogStatus]
IgnoreProlileOn=comma_delimited_list_of_system_IDs
ForceSupportOn=comma_delimited_list_of_system_IDs
Channel=IPMB
NetFnLUN=0x28
CMD=0x5A
ReqDataLen=1
ReqData=1
CCode=0xC1
SupportedDefault=True
SupportedOutput=False
#// ---- Info for Restore Defaults ----
[RestoreDefaults]
IgnoreProlileOn=comma_delimited_list_of_system_IDs
ForceSupportOn=comma_delimited_list_of_system_IDs
Channel=IPMB
NetFnLUN=0xF8
CMD=0x0D
ReqDataLen=1
ReqData=0
CCode=0xC1
SupportedDefault=False
SupportedOutput=True

Still referring to FIG. 4, for platforms using IPMI 2.0, at least one embodiment of method 400 proceeds from 420 to 451, where it issues the GetCommandSupport command for each combination of channel, NetFn and LUN. The GetCommandSupport command causes the platform management system to return bit values for commands 00h through 7Fh or 80h through FFh. For each command, the program looks for a matching channel, NetFnLUN and command in the command configuration file at 453.

If no match is found, the program will try next command. If a match is found at 453, method 400 proceeds to 455, and uses the system ID to determine if profiling of this command on should be ignored. If 455 determines that the command should be ignored, method 400 proceeds to 459, where the default value of the command is obtained, according to at least one embodiment, from the command configuration file. The method then proceeds to 461, where an attribute of the command, e.g. SupportedOutput, in the configuration file is updated to indicate whether the command is supported or not If the method determines at 455 that the command should not be ignored, at least one embodiment checks the bit value returned for the command in response to the GetCommandSupport command to ensure that the command is supported on the system. If the command is supported on this platform, the method proceeds to 461 where the command configuration file is updated accordingly. After updating the command configuration file at 461, method 400 may return to 453 or 451 to evaluate support for other commands.

It should be appreciated that the methods described above, although illustrated and discussed as performing particular tasks in a particular order, may be implemented in various ways involving additional or fewer actions, or actions performed in an order different than the order discussed.

Implementing various embodiments of the above methods, or combinations of the above methods, may provide a way to turn off profiling of a command based on system ID, which can be useful if executing a command on a particular system can cause harm to the system. Various embodiments also allow the decision to override an otherwise unsupported command. Furthermore, at least one embodiment can be implemented using a configuration file, and does not require that the binary code be revised.

Although the disclosed embodiments have been described in detail, it should be understood that various changes, substitutions and alterations can be made to the embodiments without departing from their spirit and scope.

What is claimed is:

1. A method of providing information associated with functionality of a platform management subsystem to software applications, the method comprising:
determining, for a plurality of platform management commands, whether functionality associated with respective commands is supported by the platform management subsystem; and
storing results of the determining in a file accessible to at least presentation layer applications.

2. The method of claim 1, wherein the determining whether the functionality is supported by the platform management subsystem comprises:
identifying a parameter of a command associated with the platform management subsystem;
attempting to set the parameter to each of a plurality of parameter values; and
determining if respective parameter values are supported based on a completion code provided by the platform management subsystem.

3. The method of claim 2, wherein the determining whether the functionality is supported by the platform management subsystem further comprises:
saving an initial parameter value prior to an initial attempt to set; and
restoring the initial parameter value after a final attempt to set.

4. The method of claim 2, wherein the determining whether the functionality is supported by the platform management subsystem further comprises identifying the parameter based on a configuration file.

5. The method of claim 2, wherein at least a portion of the plurality of parameter values are specified by an intelligent platform management interface (IPMI) specification.

6. The method of claim 1, wherein the determining whether the functionality is supported by the platform management subsystem comprises determining if a command is supported.

7. The method of claim 6, wherein the determining if a command is supported comprises:
attempting to issue the command to the platform management subsystem;
receiving a completion code; and
determining if the command is supported is based on the completion code.

8. The method of claim 6, wherein the determining if a command is supported comprises commanding the platform management subsystem to provide information identifying supported commands.

9. The method of claim 6, further comprising forcing support for a command in accordance with a configuration file.

10. An information handling system comprising:
a platform management subsystem;
a processor;
memory operably associated with said processor; and
a program of instructions storable in said memory and executable by said processor, said program of instructions to implement a method comprising:
determining, for a plurality of platform management commands, whether functionality associated with respective commands is supported by the platform management subsystem; and
storing results of the determining in a file accessible to at least presentation layer applications.

11. The information handling system of claim 10, wherein the determining whether the functionality is supported by the platform management subsystem comprises:
identifying a parameter of a command associated with the platform management subsystem;
attempting to set the parameter to each of a plurality of parameter values; and
determining if respective parameter values are supported based on a completion code provided by the platform management subsystem.

12. The information handling system of claim 11, wherein the determining whether the functionality is supported by the platform management subsystem further comprises:
saving an initial parameter value prior to an initial attempt to set; and
restoring the initial parameter value after a final attempt to set.

13. The information handling system of claim 11, wherein at least a portion of the plurality of parameter values are specified by an intelligent platform management interface (IPMI) specification.

14. The information handling system of claim 10, wherein the determining whether the functionality is supported by the platform management subsystem comprises determining if a command is supported.

15. The information handling system of claim 14 wherein the determining if a command is supported comprises
attempting to issue the command to the platform management subsystem;
receiving a completion code; and
determining if the command is supported is based on the completion code.

16. The information handling system of claim 14, wherein the determining if a command is supported comprises commanding the platform management subsystem to provide information identifying supported commands.

17. The information handling system of claim 14, further comprising forcing support for a command in accordance with a configuration file.

18. A computer readable medium tangibly embodying a program of executable instructions, said program of instructions comprising:
at least one instruction to determine, for a plurality of platform management commands, whether functionality associated with respective commands is supported by a platform management subsystem; and
at least one instruction to store results of the determining in a file accessible to at least presentation layer applications.

19. The computer readable medium of claim 18, wherein the at least one instruction to determine comprises:
at least one instruction to identify a parameter of a command associated with the platform management subsystem;
at least one instruction to attempt to set the parameter to each of a plurality of parameter values; and
at least one instruction to determine if respective parameter values are supported based on a completion code provided by the platform management subsystem.

20. The computer readable medium of claim 19, wherein the at least one instruction to determine comprises:
at least one instruction to save an initial parameter value prior to an initial attempt to set; and
restoring the initial parameter value after a final attempt to set.

21. The computer readable medium of claim 18, wherein the at least one instruction to determine comprises at least one instruction to determine if a command is supported.

22. The computer readable medium of claim 21, wherein the at least one instruction to determine comprises:
at least one instruction to issue the command to the platform management subsystem; and
at least one instruction to determine if the command is supported based on a completion code.

23. The computer readable medium of claim 21, wherein the at least one instruction to determine comprises commanding the platform management subsystem to provide information identifying supported commands.
